(19) United States
(12) Patent Application Publication
(10) Pub. No.: US 2001/0020474 A1
(43) Pub. Date: Sep. 13, 2001

(54) Nasal breathing mask and mask cushion for a nasal breathing mask

(76) Inventors: Karl Heinz Hecker, Aschau im Chiemgau (DE); Rudolf A. Schingagl, Unterhaching (DE)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/765,792

(22) Filed: Jan. 18, 2001

(30) Foreign Application Priority Data
Jan. 21, 2000 (DE) 100 02 571.4
Jan. 21, 2000 (DE) 200 01 040.9

(51) Int. Cl. A62B 18/02

(52) U.S. Cl. 128/206.28; 128/207.11

(57) ABSTRACT

The invention relates to a nasal breathing mask and a mask cushion for a nasal breathing mask. The nasal breathing mask comprises a mask cushion and a mask-holding part, which is connected to a hose connection for a breathing hose, and at least one strap for positioning the breathing mask on the face, in particular on the nose, of a user. Together with the mask part, the mask cushion for the nasal breathing mask forms an inner space for accommodating at least the nose of the user. The mask cushion consists of flexible material with a sealing lip, the sealing lip, when the breathing mask is being used, bearing in a sealed manner on the face of the user by means of a part of its outer surface and, in the process, being deformed. In the bearing part, the sealing lip delimits an opening to the inner space by means of an edge and may have a thickened section. Furthermore, the mask cushion may have an inner supporting wall and a sealing lip wrapped inwardly around the supporting wall, the sealing lip running on that side of the supporting wall which is remote from the inner space and being spaced apart from this wall, and the supporting wall being provided with webs which, when the breathing mask is being used, reduce the deformation thereof.

The invention relates to a nasal breathing mask in accordance with claim 22 or 23 and to a mask cushion for a nasal breathing mask in accordance with claim 1 or 12.

Nasal breathing masks are used to supply respiratory air, for example for medical or therapeutic purposes.

Nasal breathing masks usually comprise a mask-holding part with at least one strap for positioning the breathing mask on the face, in particular the nose, of a user, and a partially elastic, anatomically shaped mask cushion which may be releasably connected to the mask-holding part. In this way, the breathing mask is pressed against the face of the user. The respiratory air can be supplied through a breathing hose via a hose connection on the mask-holding part. The respiratory air is taken from a unit which generates superatmospheric pressure.

The mask cushions of the prior art which are conventionally used usually consist of a flexible material. The region of such mask cushions which connects the nasal breathing mask in a sealed manner to the face of a user or encloses at least a part of the face of a user in a sealed manner usually comprises an air- or fluid-filled cushion or simply comprises a bead-like molded-out section of the flexible mask-cushion material. However, when corresponding mask cushions are used, leaks may occur if the mask cushion slips on the face of the user, for example by forces caused by violent head movements of the user. This is usually prevented or restricted by the fact that the nasal breathing masks which use mask cushions of this type are pressed particularly firmly onto the face or the facial contour of the user by corresponding straps. This significantly reduces the wearing comfort which can be achieved by nasal breathing masks with mask cushions of this type.

In a second type of mask cushion which is used with nasal breathing masks, an inwardly wrapped sealing section of the mask cushion, which is very flexible, is arranged in such a way that, when a nasal breathing mask with a corresponding mask cushion is used, it seals the mask cushion or the nasal breathing mask on the face of the user through the pressure of the respiratory gas. Although the forces which are required for this type of mask cushion in order to position and hold the entire nasal breathing mask in a sealed manner are significantly lower than with a mask cushion as described further above, the fact that the accurate bearing of the very flexible part of the mask cushion on the face of a user is responsible for the sealing means that it is imperative that this flexible section of the mask cushion bear soundly and reliably against the facial contour of the user. In particular, there must be no creases or the like in the corresponding region of the mask cushion. On account of the very flexible design of corresponding mask cushions, creases or the like may occur even when the mask cushion is being positioned or when the user moves, i.e. as a result of deformation of the mask cushion. The result is that the sealing properties of mask cushions of this type are not optimal.

To ensure that the breathing mask is comfortable to wear and functions correctly, it is necessary for the flexible material of the mask cushion to be designed to be as thin-walled as possible. However, these thin-walled mask cushions entail the problem of not being very durable, i.e., when the breathing mask is used for a prolonged period or after it has been put on and taken off a number of times, cracks form, in particular around the opening in the mask cushion which serves to accommodate the nose, so that the sealing effect is no longer provided. Frequent exchange or replacement of the mask cushion of a breathing mask of this type causes considerable cost to the user.

The object of the invention is to overcome the drawbacks of the prior art and, in particular, to provide a mask cushion or a nasal breathing mask which offers very good sealing properties combined, at the same time, with a high wearing comfort and reliable handling, and at the same time also has excellent durability and therefore a longer service life.

The object of the invention is achieved by means of a mask cushion in accordance with claim 1 or 12 and a nasal breathing mask in accordance with claim 22 or 23.

Preferred configurations of the invention are defined in the respective dependent claims.

The mask cushion according to the invention is intended for a nasal breathing mask and, for sealed connection to the face of a user, can be arranged on a mask-holding part, the mask-holding part and the mask cushion forming an inner space for accommodating at least the nose of the user. According to the invention, the mask cushion consists of a flexible material, with an inner supporting wall and with a sealing lip wrapped inwardly around the supporting wall. The sealing lip runs on that side of the supporting wall which is remote from the inner wall and is spaced apart from this wall. When the breathing mask is being used, the sealing lip bears in a sealed manner on the face of the user by means of a part of its outer surface and, in the process, is deformed toward the supporting wall. According to the invention, the supporting wall is provided with webs which, when the breathing mask is being used, reduce the deformation thereof.

The inventive design of the mask cushion with an internal supporting wall and a sealing lip which is wrapped inwardly around the supporting wall, the supporting wall being provided with webs which stiffen the supporting wall and thus reduce its deformation when the breathing mask is being used, ensures that there is a securely sealed connection between the mask cushion and the face of the user without the mask cushion having to be pressed onto the face of the user with an excessively high force. The deformation resistance prevents the formation of creases which could reduce or even eliminate the sealing effect of the mask cushion.

It is particularly advantageous if the supporting wall of the mask cushion according to the invention is provided with the corresponding webs on its inwardly facing surface, i.e. its side which faces toward the inner space, and/or on its outwardly facing surface, i.e. on its side which is remote from the inner space. Particularly when the webs are arranged on the inwardly facing surface of the supporting wall, the sealing lip, which runs substantially on that side of the supporting wall which is remote from the inner space, is prevented from bearing too closely against the molded-out webs of the supporting wall and possibly slipping between them in sections, thus once again incurring the risk of creases being formed. Arranging correspondingly molded-out webs on both surfaces of the supporting wall once again makes it possible to achieve a particularly deformation-resistant design of the mask cushion.

In a particularly advantageous embodiment of the invention, the webs run substantially perpendicularly with respect to an encircling edge of the supporting wall. In this case, this edge is the encircling end of the supporting wall. The substantially perpendicular arrangement of the webs makes it easy to reduce the deformation, since the forces which occur as a result of the nasal breathing mask being positioned usually run substantially perpendicular to the bearing surface on the facial contour and thus in turn substantially perpendicularly to the end edge of the supporting wall.

In particular, however, it may also be advantageous for the webs to be arranged substantially obliquely with respect to the encircling edge of the supporting wall. This is advantageous since, in particular in certain regions of the contact between the mask cushion and the face of a user, the direction of the deformation forces which occur in use does not necessarily run perpendicularly to the face/the facial contour of the user or to the encircling edge of the supporting wall. Rather, corresponding forces may also act obliquely on the mask cushion according to the invention, in particular in the event of pivoting movements of the head, so that in this case particularly high resistance to deformation is achieved in a controlled manner by orienting the webs in the corresponding directions of the deformation forces, since these deformation forces can in this way be absorbed particularly well without leading to corresponding deformation.

Naturally, it is also possible for the webs to be distributed perpendicularly and/or obliquely over the circumference of the mask cushion, depending on requirements corresponding to the contour of the face of a user.

To ensure acceptable wearing properties even in the event of the mask cushion according to the invention being pressed on relatively strongly, the encircling edge of the supporting wall may be wrapped over inward. Therefore, in extreme cases, its edge does not lie in the direction of the face of a user, but rather forms a rounded region which faces toward the face of a user.

It is preferable for the sealing lip of the mask cushion to be designed to be more flexible than the supporting wall. In this way it is possible to optimally ensure on the one hand a good seal and on the other hand a high deformation resistance.

It is particularly advantageous for the sealing lip to be designed with a lower material thickness than the supporting wall.

To improve the dimensional stability and durability of the extremely flexible sealing lip without restricting the good wearing properties, it is particularly advantageous if the sealing lip of the mask cushion, in one embodiment of the invention, has an encircling edge, which is provided with a thickened section or bead, on its inwardly wrapped region. This prevents the sealing lip from tearing in this region.

The flexible mask cushion can be arranged on the mask-holding part, the mask-holding part and the mask cushion forming an inner space for accommodating at least the nose of a user. The sealing lip of the mask cushion, which, when the breathing mask is being used, bears in a sealed manner against the face of the user by means of a part of its outer surface, delimits in the bearing part according to the invention, an opening to the inner space by means of an edge, and the edge has a thickened section or a bead.

The inventive configuration of the mask cushion with a thickened section around the opening which serves to accommodate a nose preserves both the flexibility and the wearing comfort of the mask cushion while nevertheless being durable and resistant to tearing. The thickened section allows the edge of the opening to withstand forces acting thereon more successfully. Therefore, tearing of the mask cushion is to a very large extent ruled out. The mask cushion can be used for a long period by a user, saving the user unnecessary expense on replacement cushions or completely new breathing masks. The edge region which has been thickened in this way also produces an improved sealing action, since it has greater dimensional stability.

In a preferred exemplary embodiment of the mask cushion, the thickened section is designed so as to encircle the entire opening. This encircling design of the thickened section provides the maximum possible durability of the mask cushion and also simplifies its production. The mask cushion preferably consists of a flexible, elastic material. Silicone is particularly suitable, although it is also possible to use other flexible materials which are tolerated by the skin.

In one embodiment of the invention, the connection between the mask cushion and the mask part is preferably made by latching an integrally molded, encircling bead on the mask cushion in an encircling, groove-like recess in the mask part.

It is ergonomically particularly preferable for the mask cushion, according to another embodiment of the invention, to be of substantially triangular basic shape and, particularly preferably, for the inner supporting wall and the sealing lip of the mask cushion or the mask cushion per se to have an encircling contour which substantially corresponds to the general facial contour of a user. In this context, the term general facial contour of a user is to be understood as meaning the facial contour which, for example when a nasal breathing mask is put on, appears in the region around the nose of a user.

The mask cushion according to the invention preferably consists of silicone, although it is also possible to use other flexible materials which are tolerated by the skin.

A nasal breathing mask according to the invention substantially has a mask cushion and a mask-holding part, the mask-holding part being connected to a hose connection for a breathing hose. Furthermore, the nasal breathing mask has at least one strap which is used to position the breathing mask on the face, in particular on the nose of a user. In this case, the mask cushion and the mask-holding part are provided in accordance with the features of claim 1 and/or 12. The preferred configurations of the mask cushion which emerge from the corresponding subclaims and the description are also to be provided in conjunction with the nasal breathing mask according to the invention.

The nasal breathing mask according to the invention is particularly easy to handle in a preferred embodiment if the strap of the nasal breathing mask has a quick-acting closure for releasably positioning the breathing mask. This allows particularly simple handling and, on account of the inventive design, in particular also of the mask cushion, the positioning of the breathing mask, which can be carried out rapidly, means that the seal or the wearing comfort of the nasal breathing mask cannot be impaired as a result of any deformations which result and are produced by the quick-acting closure and the particularly quick process of putting on and taking off the nasal breathing mask.

The invention is explained in more detail below with reference to the appended drawing, in which:

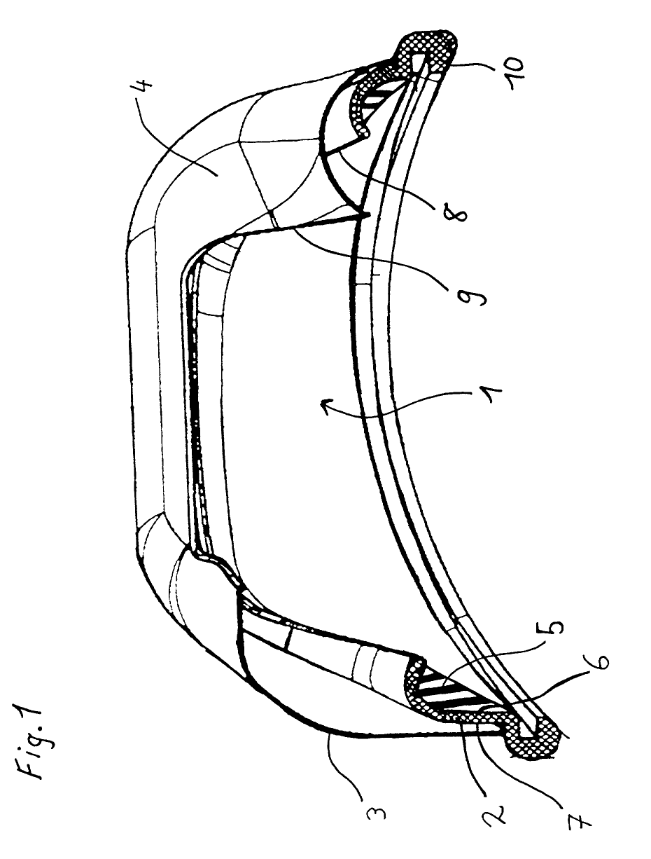

FIG. 1 shows a partially sectional, perspective view of a mask cushion for a nasal breathing mask according to a first preferred embodiment of the invention.

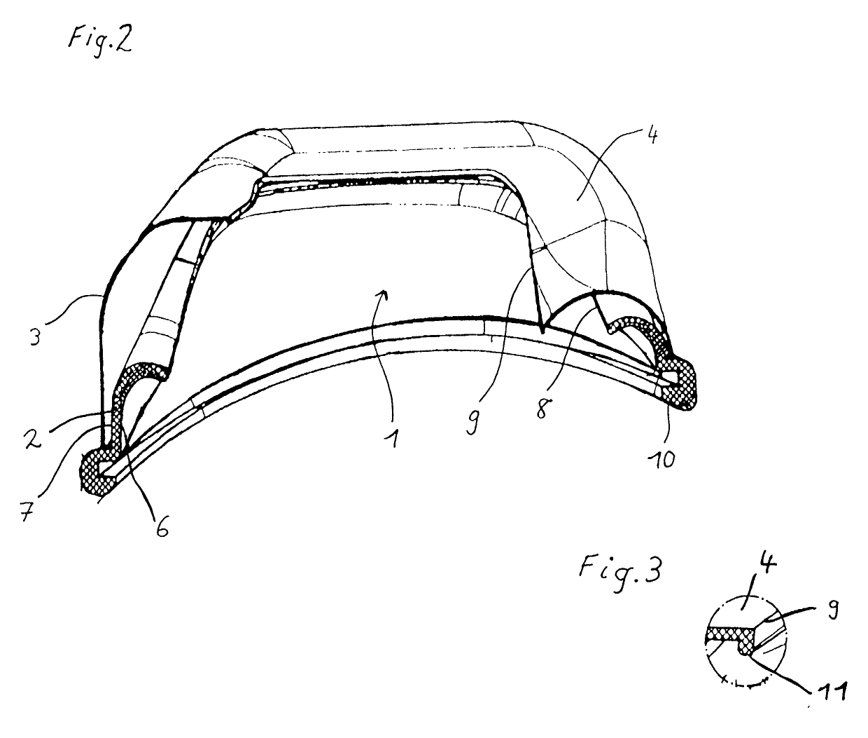

FIG. 2 shows a partially sectional, perspective view of a mask cushion for a nasal breathing mask according to a second preferred embodiment of the invention.

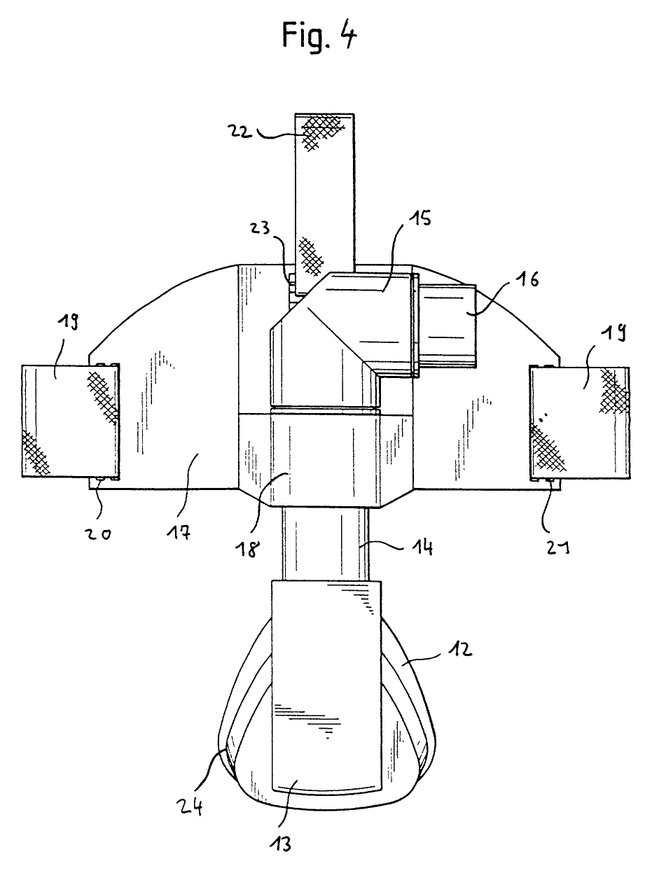

FIG. 3 shows an enlarged excerpt of the thickened section of the mask cushion according to the invention shown in FIGS. 1 and 2.

FIG. 4 shows a diagrammatic front view of a nasal breathing mask.

FIG. 1 shows the mask cushion according to the invention in accordance with a first preferred embodiment of the invention, without the associated corresponding nasal breathing mask being illustrated.

The mask cushion shown, in order to be connected in a sealed manner to the face of a user, can be attached to a mask-holding part (not shown), mask-holding part and mask cushion forming an inner space 1 for accommodating at least the nose of the user. The mask cushion consists of flexible material and has an inner supporting wall 2, with an inwardly facing surface 6 and an outwardly facing surface 7. A sealing lip 3 is wrapped inwardly around the supporting wall 2, the sealing lip 3, as shown in FIG. 1, running on that side of the supporting wall 2 which is remote from the inner space, i.e. on the side of the outwardly facing surface 7 of the supporting wall 2. Furthermore, the sealing lip 3 is spaced apart from the supporting wall 2. The sealing lip 3 has a part 4 of its outer surface which, when the breathing mask is being used, bears in a sealed manner against the face of the user. In the process, the sealing lip 3 is deformed toward the supporting wall 2. Furthermore, the sealing lip 3 has an encircling edge 9, which is provided with a thickened section 11, of its inwardly wrapped part 4, which is illustrated on an enlarged scale and in detail in FIG. 3. In the embodiment shown, the edge 8 of the supporting wall 2 is also wrapped inward toward the inner space 1. The mask cushion can be connected to the mask part as a result of an integrally molded, encircling bead 10 being latched in a corresponding encircling, groove-like recess in the mask part.

According to the invention, webs 5 are provided which, during use, reduce the deformation of the supporting wall 2. In the embodiment shown, the webs 5 are arranged on the inwardly facing surface 6 of the supporting wall 2, i.e. on that side of the supporting wall 2 which faces toward the inner space 1, and substantially perpendicularly with respect to the edge 8 of the supporting wall 2. The supposed inclined position of the webs can be seen from the perspective illustration shown in FIG. 1.

The mask cushion of the embodiment of the invention which is shown is of substantially triangular basic shape; the perspective view shown in FIG. 1 and the section through the mask cushion mean that this basic shape is difficult to perceive.

The entire nasal breathing mask is not shown in FIG. 1. In its preferred embodiment, however, the nasal breathing mask according to the invention has a mask cushion which corresponds to the mask cushion illustrated in FIG. 1.

FIG. 2 shows a second embodiment of the mask cushion according to the invention. The flexible mask cushion and the mask-holding part (not shown) form an inner space 1 which serves to accommodate the nose of a user. The mask cushion has an inner supporting wall 2 with an inwardly facing surface 6. A sealing lip 3 is wrapped inwardly around the supporting wall 2, the sealing lip 3 running on that side of the supporting wall 2 which is remote from the inner space 1. Between the sealing lip 3 and the supporting wall 2—as illustrated here in the load-free state—there is a narrow space. The sealing lip 3 has a part 4 on its outer surface which, when the breathing mask is being used, bears in a sealed manner against the face of the user. Furthermore, in the bearing part 4 the sealing lip 3 has an edge or a rim 9 which delimits an opening to the inner space 1. The edge 9 is provided with a thickened section 11 which runs all the way around the opening and is illustrated on an enlarged scale and in detail in FIG. 3. The mask cushion has an integrally molded, encircling bead 10 which, in order to be secured to the mask-holding part, engages in a groove-like recess therein (not shown).

FIG. 3 shows an enlarged excerpt of FIGS. 1 and 2, in which the thickened section 11 running around the opening of the sealing lip 3 is shown, the material thickness of the sealing lip 3 being approximately doubled in the boundary region or in the region of the edge 9.

FIG. 4 shows a diagrammatic front view of a nasal breathing mask.

The embodiment of a nasal breathing mask which is shown in FIG. 4 comprises a flexible mask part 12 according to the invention for adapting the breathing mask to the anatomy of the patient. The flexible mask part 12 is releasably connected to a mask-holding part 13.

An elongate tube 14, which is arranged vertically, is attached to the mask-holding part 13.

At the upper end of the tube 14 there is an angle tube 15. The angle tube 15, which is designed as an elbow, is designed so that it can be turned radially toward the elongate tube 14. At the free end of the horizontal part of the angle tube 15 there is a hose connection 16 for a breathing hose (not shown). To additionally increase the freedom of movement, this hose connection 16 can be rotated axially around the horizontal part of the angle tube 15.

By means of the forehead-plate mount 18, a plate 17 is mounted on the elongate tube 14 in such a manner that it can be displaced between stops on the mask-holding part 13 and the vertical part of the angle tube 15.

A strap 19 is attached to the forehead plate 17 by means of eyelets 20 and 21, so that its length can be adjusted. In addition to the strap 19, a strap 22 is likewise secured in an eyelet 23 to the upper side of the forehead plate 17, which additional strap, in order to hold the nasal breathing mask in a stable position, is guided over the head and at the back of the head is connected to the strap 19. In the exemplary embodiment shown, the straps consist of an elastic material.

The nasal breathing mask is positioned by pulling the unit over the head of the user. In the process, the optimum distance between the forehead plate 17 with the strap 19 and the mask part 12, which results from the anatomy of the user, is set by the displacement of the forehead-plate mount 18 on the elongate tube 14. Moreover, the adjustment of the strap 19 and of the additional strap 22 by means of the eyelets 20, 21, 23 adapts the way in which the breathing mask is held to the shape of the user's head, and the breathing mask is fixed in the desired way by tightening the straps to different degrees. The breathing hose is connected via the hose connection 16.

The connection between the mask part 12 and the mask-holding part 13 is made in such a manner that an annular bead 10, which is pressed into an annular recess 24 in the mask-holding part, is molded out in the mask part 12, which consists of elastic material. In this way, the mask part 12 and the mask-holding part 13 are connected to one another in a mechanically stable and airtight manner as illustrated.

### LIST OF REFERENCE NUMERALS

1 Inner space

2 Supporting wall

3 Sealing lip

4 Bearing part

5 Webs

6 Inwardly facing surface

7 Outwardly facing surface

8 Edge

9 Edge

10 Bead

11 Thickened section

12 Mask part

13 Mask-holding part

14 Elongate tube

15 Angle tube

16 Hose connection

17 Forehead plate

18 Forehead-plate mount

19 Strap

20 Eyelet

21 Eyelet

22 Strap

23 Eyelet

24 Recess

1. A mask cushion for a nasal breathing mask, which for sealed connection to a face of a user can be arranged on a mask-holding part, mask-holding part and mask cushion forming an inner space (1) for accommodating at least the nose of the user, made from flexible material, having an inner supporting wall (2) and a sealing lip (3) wrapped inwardly around the supporting wall (2), the sealing lip (3) running on that side of the supporting wall (2) which is remote from the inner space (1) and being spaced apart from this wall, the sealing lip (3), when the breathing mask is being used, bearing in a sealed manner on the face of the user by means of a part (4) of its outer surface and, in the process, being deformed toward the supporting wall (2), and the supporting wall (2) being provided with webs (5) which, when the breathing mask is being used, reduce the deformation thereof.

2. The mask cushion for a nasal breathing mask as claimed in claim 1, wherein the supporting wall (2) is provided with webs (5) on its inwardly facing surface (6) and/or on its outwardly facing surface (7).

3. The mask cushion as claimed in claim 1 or 2, wherein the webs (5) run substantially perpendicularly with respect to an encircling edge (8) of the supporting wall (2).

4. The mask cushion as claimed in claim 1 or 2, wherein the webs (5) run substantially obliquely with respect to an encircling edge (8) of the supporting wall (2), in particular in the direction of deformation forces which occur during use.

5. The mask cushion as claimed in claim 3 or 4, wherein the encircling edge (8) of the supporting wall (2) is wrapped over inward.

6. The mask cushion as claimed in one of claims 1 to 5, wherein the sealing lip (3) is more flexible than the supporting wall (2).

7. The mask cushion as claimed in one of claims 1 to 6, wherein the sealing lip (3) is designed with a lower material thickness than the supporting wall (2).

8. The mask cushion as claimed in one of claims 1 to 7, wherein the sealing lip (3) has an encircling edge (9), which is provided with a thickened section (11), on its inwardly wrapped part.

9. The mask cushion as claimed in one of claims 1 to 8, which can be connected to the mask part as a result of an integrally molded, encircling bead (10) being latched in an encircling, groove-like recess in the mask part.

10. The mask cushion as claimed in one of claims 1 to 9, which is of substantially triangular basic shape and wherein the inner supporting wall (2) and the sealing lip (3) have an encircling contour which substantially corresponds to the general facial contour of a user.

11. The mask cushion as claimed in one of claims 1 to 10, which consists of silicone.

12. A mask cushion for a nasal breathing mask, which is flexible and can be arranged on a mask-holding part, mask-holding part and mask cushion forming an inner space (1) for accommodating at least the nose of a user, having a sealing lip (3) which, when the breathing mask is being used, bears in a sealed manner on the face of the user by means of a part (4) of its outer surface, the sealing lip (3), in the bearing part (4), delimiting an opening to the inner space (1) by means of an edge (9), and the edge (9) having a thickened section (11).

13. The mask cushion as claimed in claim 12, in which the edge (9) of the opening is designed as an encircling thickened section (11).

14. The mask cushion as claimed in claim 12 or 13, which consists of flexible material, in particular of silicone.

15. The mask cushion as claimed in one of claims 12 to 14, which has an integrally molded bead (10) which, in order to be attached to the mask-holding part, engages in a groove-like recess therein.

16. The mask cushion as claimed in one of claims 12 to 15, which has an inner supporting wall, the sealing lip (3) being wrapped inwardly around the supporting wall.

17. The mask cushion as claimed in claim 16, in which the sealing lip (3) is designed with a lower material thickness than the supporting wall.

18. The mask cushion as claimed in claim 16 or 17, in which the sealing lip (3) is more flexible than the supporting wall.

19. The mask cushion as claimed in one of claims 16 to 18, in which the supporting wall is provided with webs which, when the breathing mask is being used, reduce the deformation thereof.

20. The mask cushion as claimed in claim 19, in which the supporting wall is provided with webs on its inwardly facing surface, the webs running substantially perpendicularly with respect to an encircling edge of the supporting wall.

21. The mask cushion as claimed in claim 19, in which the webs run substantially obliquely with respect to the encircling edge of the supporting wall.

22. A nasal breathing mask having a mask cushion and a mask-holding part which is connected to a hose connection for a breathing hose, and having at least one strap for positioning the breathing mask on the face, in particular on the nose of a user, mask-holding part and mask cushion forming an inner space (1) for accommodating at least the nose of the user, and the mask cushion consisting of flexible material, having an inner supporting wall (2) and a sealing lip (3) wrapped inwardly around the supporting wall (2), the sealing lip (3) running on that side of the supporting wall (2) which is remote from the inner space (1) and being spaced apart from this wall, the sealing lip (3), when the breathing mask is being used, bearing in a sealed manner on the face of the user by means of a part (4) of its outer surface and, in the process, being deformed toward the supporting wall (2), and the supporting wall (2) being provided with webs (5) which, when the breathing mask is being used, reduce the deformation thereof caused by the deformation forces which occur as a result of the positioning by the strap.

23. A nasal breathing mask having a mask cushion, in particular having the features as claimed in one of claims 12 to 21, and a mask-holding part, which is connected to a hose connection for a breathing hose and has at least one strap for positioning the breathing mask on the face, in particular on the nose of a user, mask-holding part and mask cushion forming an inner space (1) for accommodating at least the nose of a user, the mask cushion having a sealing lip (3) which, when the breathing mask is being used, bears in a sealed manner on the face of the user by means of a part (4) of its outer surface, the sealing lip (3), in the bearing part (4), delimiting an opening to the inner space (1) by means of an edge (9), and the edge having a thickened section (11).

24. The nasal breathing mask as claimed in claim 22 or 23, in which the strap has a quick-acting closure for releasably positioning the breathing mask.
